(19) United States
(12) Patent Application Publication
(10) Pub. No.: US 2008/0286101 A1
(43) Pub. Date: Nov. 20, 2008

(54) FAN WITH POWER ADJUSTABLE HOUSING

(75) Inventors: Mark Gajewski, Avila Beach, CA (US); William Patrick Conley, Camarillo, CA (US); Rodger Dale Thomason, Santa Monica, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: SWISS MODULE GROUP, LLC, Fontana, CA (US)

(21) Appl. No.: 12/123,402

(22) Filed: May 19, 2008

Related U.S. Application Data
(60) Provisional application No. 60/930,667, filed on May 18, 2007.
(60) Provisional application No. 60/930,641, filed on May 18, 2007.
(60) Provisional application No. 60/930,642, filed on May 18, 2007.
(60) Provisional application No. 61/021,088, filed on Jan. 15, 2008.
(60) Provisional application No. 61/021,232, filed on Jan. 15, 2008.
(60) Provisional application No. 61/021,265, filed on Jan. 15, 2008.

(30) Foreign Application Priority Data
May 17, 2008 (US) PCT/US08/64022
May 17, 2008 (US) PCT/US08/64024
May 17, 2008 (US) PCT/US2008/064023

(51) Int. Cl. B64C 27/59

(52) U.S. Cl. 416/23

(57) ABSTRACT

A ceiling mounted fan comprising: a first housing portion; a second housing portion; and a motive unit operably coupled to the second housing portion, wherein the motive unit is configured to adjust a position of the second housing portion from a position proximate to the first housing portion to a position distal to the first housing portion.

This application claims priority under 35 U.S.C. 119(e) to the following United States provisional patent applications:

60/930,641, filed May 18, 2007 of Gajewski et al., for MOVABLE DECORATIVE HOUSING ELEMENTS FOR CEILING FANS;

60/930,642 filed May 18, 2007 of Gajewski et al., for POWERED BLADE DEPLOYMENT AND RETRACTION OF CEILING FANS;

60/930,667 filed May 18, 2007 of Gajewski et al., for POWERED BLADE PITCH ADJUSTMENT FOR CEILING FANS;

61/021,088 filed Jan. 15, 2008, of Gajewski et al., for BLADE CONCEALMENT METHODS FOR CEILING FANS;

61/021,232 filed Jan. 15, 2008 of Gajewski et al., for DEPLOYABLE BLADE CEILING FAN WITH STACKED MODULES; and

61/021,265 filed Jan. 15, 2008 of Gajewski et al., for INDEPENDENTLY POWERED BLADE DEPLOYMENT MECHANISM FOR CEILING FANS.

This application is also a continuation of the following international applications:

Patent Cooperation Treaty Application No. PCT/U.S.08/64022 filed May 17, 2008, of Gajewski et al., for FAN WITH POWER ADJUSTABLE HOUSING;

Patent Cooperation Treaty Application No. PCT/U.S.08/64023 filed May 17, 2008, of Gajewski et al., for FAN WITH POWER DEPLOYED FAN BLADE; and

Patent Cooperation Treaty Application No. PCT/U.S.08/64024 filed May 17, 2008, of Gajewski et al., for FAN WITH ADJUSTABLE FAN BLADE PITCH.

All of these above-identified applications are expressly incorporated herein by reference as if set forth in their entirety.

This application relates to ceiling fans described in the following applications filed concurrently herewith. The related applications, all of which are incorporated herein by reference, are: U.S. patent application Ser. No. ______, to Gajewski et al., entitled Fan with Power Adjustable Fan Blade Pitch; and U.S. patent application Ser. No. ______, to Gajeswki et al., entitled Fan with Power Deployed Fan Blade.

### BACKGROUND OF THE INVENTION

1. Field of the Invention

The present invention relates generally to fans, and more specifically to active (e.g., directly powered) deployment of the blades of a fan and active concealment of fan blades. More particularly, the present invention relates generally to active, non centrifugal deployment of air moving blades for ceiling fans from a stowed (or stored) position to a deployed (or use) position, involving adjusting fan housing.

While this application focuses on fans (e.g. ceiling fans), the present invention is not limited to fans as it can be applied to countless other devices and systems, such as plane or boat propulsion systems, portable blowers, pump systems, and airplane emergency landing systems.

2. Discussion of the Related Art

Electric ceiling fans are commonly utilized to assist heating and air conditioning systems, or in lieu of heating and air conditioning systems by providing an additional degree of air circulation within the confines of a room. Most modern ceiling fans consist of an electric motor suspended by a shaft from a ceiling, with a plurality of blades mounted to either the top or bottom surface of the motor. Conventional ceiling fans typically incorporate one or more electrical switches for controlling the speed and rotational direction of the motor, with the switches encased within a switch housing disposed beneath the motor, or in an electrical box located in or on an adjacent wall.

In the case of ceiling fans having blades mounted to the bottom surface of the motor, blade irons to which the blades are secured are typically rigidly attached to the motor by means of a plurality of screws. While blade irons can be quite decorative, the multiplicity of screws utilized to secure blade irons to the blades and the motor are unsightly. In addition, even decorative blade irons may not yield an aesthetically pleasing structure when the ceiling fans are not in use.

U.S. Pat. No. 4,884,947 issued Dec. 5, 1989, entitled “CEILING FAN ASSEMBLY” demonstrates one effort to create an aesthetically pleasing ceiling fan, wherein the blade irons and associated screws are hidden from view.

There is a need in the art for a ceiling fan having a simplified, yet aesthetically pleasing structure, with an appearance suitable for use in most applications.

### SUMMARY OF THE INVENTION

In one embodiment, the invention can be characterized as a fan comprising: a first housing portion; a second housing portion; and a motive unit operably coupled to the second housing portion, wherein the motive unit is configured to adjust a position of the second housing portion from a position proximate to the first housing portion to a position distal to the first housing portion.

In another embodiment, the invention can be characterized as a fan comprising: a first housing portion; a second housing portion; and a means for positioning the second housing portion from a position proximate to the first housing portion to a position distal to the first housing portion.

In a further embodiment, the invention may be characterized as a method for adjusting a position of a fan housing unit, comprising the steps of: providing a signal to a motive unit, wherein the motive unit is operably coupled to a first housing portion; adjusting a position of the first housing portion from a position proximate to a second housing portion to a position distal to the second portion.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a perspective view of a ceiling fan in accordance with one embodiment of the present invention showing a plurality of actively deployable fan blades in a stowed (or stored) position.

FIG. 2 is a perspective view of the ceiling fan in accordance with the embodiment of FIG. 1 showing the plurality of actively deployable fan blades in a deployed (or use) position.

FIG. 3 is a perspective view of the ceiling fan in accordance with the embodiment of FIGS. 1 and 2 showing the plurality of actively deployable fan blades in a deployed (or use) position, and having their pitch altered for air movement.

FIG. 4 is an exploded perspective view of a ceiling fan with a power adjustable housing, showing a support rod, an upper housing, a main drive motor, a first (upper) deck, a fan blade, a second (lower) deck, a main drive shaft, a main drive shaft sleeve, a plate, a light cover, a light cover deployment motor, a light cover deployment motor mount, a light cover deployment light cover deployment pinion 490, and a light cover deployment rack 495.

FIG. 5 is a perspective view of a a ceiling fan in accordance with the present invention, the embodiment shown in FIG. 4, showing the plurality of actively deployable fan blades in a stowed (or stored) position, and a light cover in a stowed (or stored) position.

FIG. 6 is a perspective view of a ceiling fan in accordance with the embodiment of FIG. 5, showing the plurality of actively deployable fan blades in a stowed (or stored) position, and the light cover in a deployed (or use) position.

FIG. 7 is a perspective view of a ceiling fan in accordance with the embodiment of FIGS. 5 and 6 showing the plurality of actively deployable fan blades in a deployed (or use) position, and having their pitch altered for air movement.

FIG. 8 is a side view of a ceiling fan in accordance with the embodiment of FIGS. 4-7, showing a plate 470, a light cover 475, a main drive shaft 450, a light cover deployment motor 480, a light cover deployment motor mount 485, a light cover deployment pinion 490, and a light cover deployment rack 495.

FIG. 9 is a side view of a ceiling fan in accordance with the embodiment of FIGS. 4-8, showing a support rod 110, an upper housing 120, a second (lower) deck 440, a main drive shaft 450, a main drive shaft sleeve 460, a plate 470, a light cover deployment motor 480, a light cover deployment motor mount 485, a light cover deployment pinion 490, and a light cover deployment rack 495.

FIG. 10 is a top perspective view of a ceiling fan in accordance with the embodiment of FIGS. 4-9, showing the first (upper) deck 420, the main drive motor 410, and a top portion of the main drive shaft 450 of the embodiment of FIG. 4.

FIG. 11 is a side perspective view of a ceiling fan in accordance with the embodiment of FIGS. 4-10, showing the first (upper) deck 420, the main drive motor 410, a top portion of the main drive shaft 450, the main drive shaft sleeve 460, the plate 470, and the light cover deployment rack 495.

FIG. 12 is a top plan view of a ceiling fan in accordance with the embodiment of FIGS. 4-11, showing the first (upper) deck 420, the main drive motor 410, and a top portion of the main drive shaft 450.

FIG. 13 is a bottom plan view of a ceiling fan in accordance with the embodiment of FIGS. 4-12, showing a second (lower) deck 440, a main drive shaft sleeve 460, a plate 470, and a light cover deployment motor 480.

FIG. 14 is a side view of a ceiling fan in accordance with the embodiment of FIGS. 4-13, showing a main drive motor 410, a first (upper) deck 420, a main drive shaft 450, a main drive shaft sleeve 460, a plate 470, a light cover deployment motor 480, a light cover deployment motor mount 485, and a light cover deployment rack 495. The light cover deployment motor 480 is in a position that has closed the gap between the upper housing (not shown) and the light cover (not shown).

FIG. 15 is a side view is shown, viewed from a position 270° from that of FIG. 14, about a counter-clockwise axis of rotation of the ceiling fan in accordance with the embodiment of FIGS. 4-14, showing a first (upper) deck 420, a main drive shaft 450, a main drive shaft sleeve 460, a plate 470, a light cover deployment motor 480, and a light cover deployment motor mount 485. The light cover deployment motor 480 is in a position that has closed the gap between the upper housing (not shown) and the light cover (not shown).

FIG. 16 is a side view is shown, viewed from a position 180° from that of FIG. 14, about an axis of rotation of the ceiling fan in accordance with the embodiment of FIGS. 4-15, showing a first (upper) deck 420, a main drive shaft 450, a main drive shaft sleeve 460, a plate 470, a light cover deployment motor 480, a light cover deployment motor mount 485, and a light cover deployment rack 495. The light cover deployment motor 480 is in a position that has closed the gap between the upper housing (not shown) and the light cover (not shown).

FIG. 17 is a side view is shown, viewed from a position 90° from that of FIG. 14, about a counter-clockwise axis of rotation of the ceiling fan in accordance with the embodiment of FIGS. 4-16, showing a first (upper) deck 420, a main drive shaft 450, a main drive shaft sleeve 460, a plate 470, a light cover deployment motor 480, a light cover deployment motor mount 485, and a light cover deployment rack 495. The light cover deployment motor 480 is in a position that has closed the gap between the upper housing (not shown) and the light cover (not shown).

FIG. 18 is a side view of a ceiling fan in accordance with the embodiment of FIGS. 4-13, showing a main drive motor 410, a first (upper) deck 420, a main drive shaft 450, a main drive shaft sleeve 460, a plate 470, a light cover deployment motor 480, a light cover deployment motor mount 485, and a light cover deployment rack 495. The light cover deployment motor 480 is in a position that has opened the gap between the upper housing (not shown) and the light cover (not shown).

FIG. 19 is a perspective view of a ceiling fan in accordance with the embodiment of FIGS. 4-13, showing a main drive motor 410, a first (upper) deck 420, a main drive shaft 450, a main drive shaft sleeve 460, a plate 470, a light cover deployment motor 480, and a light cover deployment rack 495. The light cover deployment motor 480 is in a position that has opened the gap between the upper housing (not shown) and the light cover (not shown).

FIG. 20 is a side view is shown, viewed from a position 270° from that of FIG. 14, about a counter-clockwise axis of rotation of the ceiling fan in accordance with the embodiment of FIGS. 4-13, showing a first (upper) deck 420, a main drive shaft 450, a main drive shaft sleeve 460, a plate 470, a light cover deployment motor 480, and a light cover deployment motor mount 485. The light cover deployment motor 480 is in a position that has opened the gap between the upper housing (not shown) and the light cover (not shown).

FIG. 21 is a flow diagram illustrating a “startup” sequence employed by a control system for controlling the ceiling fan described of the various embodiments described hereinabove in reference to FIGS. 1 through 20.

FIG. 22 is a flow diagram illustrating a “run” sequence employed by a control system for controlling the ceiling fan described of the various embodiments described hereinabove in reference to FIGS. 1 through 20.

FIG. 23 is a flow diagram illustrating a “shutdown” sequence employed by a control system for controlling the ceiling fan described of the various embodiments described hereinabove in reference to FIGS. 1 through 20.

FIG. 24 is a flow diagram illustrating a “shutdown-reset” sequence employed by a control system for controlling the ceiling fan described of the various embodiments described hereinabove in reference to FIGS. 1 through 20.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Ceiling fan designs have been proposed to minimize the visual impact of the blades when not in use. One approach to minimizing the visual impact of the blades is to employ blades that deploy from a stored position, that is substantially close to a housing unit, to a deployed position (use position or operating position), that is away from the housing unit, for the purpose of moving air. Such a ceiling fan may at least partially hide the blades, allowing the blades to be less exposed when not in operation. Deployable blade ceiling fans heretofore however have not been able to completely hide the folded blades from view. For example, U.S. Pat. No. 7,153,100 shows an example of a deployable blade ceiling fan. As shown, the blades are nested on top of the housing when not in use, however the blades remain a strong visual element of the entire ceiling fan structure. Unfortunately for the design of the 1100 patent, there is a considerable advantage for a ceiling fan design that features deployable and retractable blades if the blades are rendered substantially invisible (i.e., concealed) when in the stowed position (stored position or retracted position) while not in use. Some advantages may be that the blades will be less subject to dust and dirt accumulation, safety, and visual appeal.

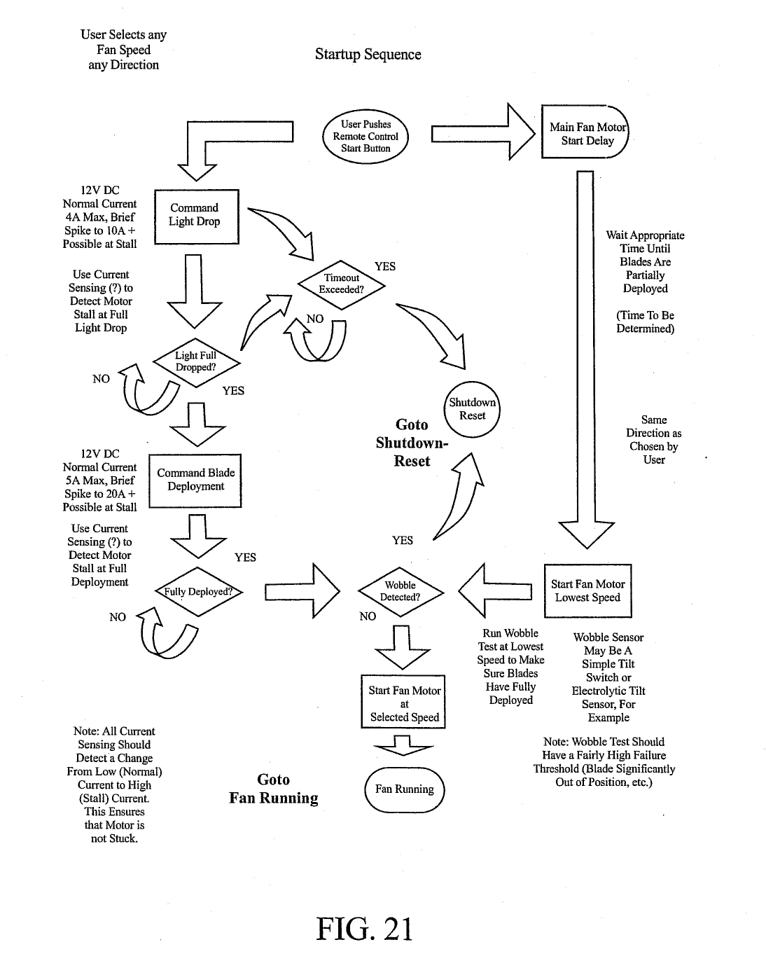

Thus, it is desirable to provide a means for substantially concealing the blades of a ceiling fan when the blades are not in use. It is also be desirable to provide concealing means for the blades for a ceiling fan that operate automatically in coordination with the means of deployment and retraction of the fan blades. A control system for controlling deployment of the blades is described more fully below herein in reference to FIGS. 21 through 24. It would also be desirable that the means of concealing the blades of a ceiling fan be such that an average observer of the ceiling fan does not observe the blades, and thus leads the observer to conclude that the ceiling fan is not a ceiling fan, but rather merely a lighting fixture. Thus when the ceiling fan is operated the observer would enjoy a visually pleasing transformation of the fixture, for example, from a lighting fixture into a ceiling fan.

When a typical ceiling fan is not operating (i.e., the blades are not moving air) the exposed resting blades can create an unsightly design feature. It is difficult to harmonize the long and flat shape of the blades with the fan body, and the surrounding architectural space as well. This problem is even more acute if the fan is mounted in a small space.

The blades may also collect dust, necessitating periodic cleaning. Such cleanings may require specialized cleaning brushes to accommodate both the awkward, flat elongate shape of the blades, and the potentially significant heights at which such ceiling fans are often mounted. It would be thus desirable to minimize the visual impact of the blades of the ceiling fan when the ceiling fan is not in operation, as well as to protect the blades of the ceiling fan from the environment outside the fixture, e.g., dust, sunlight or rain, by storing them inside an enclosed housing.

The '100 patent's design has been proposed to address the exposed blade issue. The blades are mounted on a pivot and are fitted with spring elements that urge the blades into a folded position substantially close to the housing. In normal fan operation the centrifugal force on the blades deploy the blades outward into a deployed position (or operating position).

There are several disadvantages to using this centrifugal force as a means of controlling deployment and storage of the fan blades. First, it can be difficult to control the blade deployment for different operating speeds and directions of the ceiling fan. Often the blades will not deploy in a coordinated manner, creating an imbalance during the transition from the blade storage position to the deployed position. The '100 patent attempts to address the problem of coordinated blade deployment by fitting complicated mechanical linkages and damping elements to the blades. This adds additional complexity, cost and weight to the ceiling fan.

Another disadvantage to the centrifugal force deployment method is that the blades may not fully deploy during low speed operation. This limits the range of permissible operating speeds of the ceiling fan and may still cause balance problems in operation. The blade mount locations and blade shape are limited by the need to have acceptable centrifugal force acting on them in the stored position. This imposes significant constraints on the design of the fan and can compromise the air moving capacity of the fan. This centrifugal force deployment is also referred to herein as passive deployment, as there is no direct or active control, of when or how quickly the blades deploy or retract.

Therefore, it is desirable to provide a more easy and controllable means of actively deploying and actively retracting ceiling fan blades independent of fan operating speed or direction, as imparted by a main drive motor. It is also desirable to positively position the blades in both the storage and operating positions, as opposed to the blades potentially being positioned at a point at which equilibrium is reached between spring force resultant, when a spring element exerts a spring force, and the centrifugal force resultant from the inertia of the blades being acted upon by the main drive motor. Alternatively, in accordance with the present embodiment, positive positioning of the blades may be achieved by, for example, deploying the blades to the deployed position using the deployment mechanism, and the deployment motor, and returning the blades to the retracted (or stowed position) by the use of a spring, that tensions as the blade is deployed, and relaxes as the blades are retracted. Further alternatively, positive positioning may be achieved by, for example, deploying the blades to the deployed position by the use of a spring that tensions as the blade is retracted, and relaxes as the blade is deployed, and retracting the blade to the retracted position using the deployment mechanism, and the deployment motor. Furthermore, in accordance with further embodiments, the deployment of the blades may be achieved using a single deployment motor (as opposed to a deployment motor for each blade) or any number of deployment motors less than the number of blades, in combination with one or more gears or other direct linkages that transfer rotational movement imparted by the deployment motor(s) to two or more deployment mechanisms associated with two or more blades. Additionally, in accordance with yet further embodiments, the deployment of the blades may be achieved by using one or more gears or other direct linkages to transfer rotational movement imparted by the main drive motor to two or more deployment mechanisms associated with two or more blades.

In operation, the positive, active deployment of the blades, as opposed to the deployment of the blades by the opposition of a spring force with a centrifugal force induced as a response to the rotation of the blades about an axis defined by rotation of the main motor about the main drive shaft in order to move air, ensures optimal balance of the ceiling fan and optimal air moving capacity. As stated above, it is also desirable to allow more flexibility in blade shape and mounting to improve aesthetics and air moving performance. It is also desirable to provide a pleasing visual experience to the user by deploying and retracting the fan blades, such that the fan blades are rendered substantially invisible (i.e., concealed) when in the stowed position (stored position or retracted position) while the fan is at rest.

The mechanism that deploys and retracts the fan blades should have minimal impact to the aesthetic design of the fan. It is advantageous to provide a deployment mechanism that has as many common parts as possible, over a wide variety of sizes and styles of fans. (Various mechanical power transmitting means may be incorporated into the deployment mechanism, such as gears, belts, or cables to transmit motion from the motive power source to each blade.) This confers significant economies of scale in the production of precision mechanical components for the deployment mechanism. One area of particular interest and advantage is the use of a motive power source (e.g., electric motor, solenoid, hydraulic or pneumatic cylinder, or the like) coupled to the deployment mechanism. If a central power source (single motive power source) is employed, means are necessary to transmit the power to each individual blade's deployment mechanism. This can involve gears, belts, or shafts that would have to be unique for each fan design. Balance of the overall assembly, an important design feature of ceiling fans, can be complicated by this approach as well.

It is advantageous to provide a blade deployment mechanism with each blade having its own standalone motive power source. Thus the deployment mechanism and its cooperative motive power source can be common across all fan designs, creating significant economies of scale. Having a closed deployment mechanism with its own motive power source also simplifies the balancing of the overall ceiling fan assembly.

A ceiling fan featuring deployable and retractable blades confers many advantages over a fixed-blade ceiling fan. Retracting the blades while not in use enhances visual appeal, reduces dust accumulation on the blades, reduces fading of the blades' ornamental surface, and potentially water damage to the blades. In such a ceiling fan with deployable and retractable blades, it is desirable to store the retracted blades in the minimum possible space. For simple blades of maximum size for a given housing size, the optimum storage configuration is flat (zero pitch relative to the axis of rotation of the ceiling fan) and coplanar with one another.

While numerous references are made herein to and examples described of ceiling fans, one of ordinary skill in the art will recognize that the principles, processes, and structures described herein are applicable to numerous types of fans for air movement. For example, the principles and structures described herein can be employed in wall fans, floor fans, box fans, table fans, or the like.

A module can thus be described where a plurality of retractable blades are configured essentially on the same plane. Due to storage space constraints in the fan housing, the number of retractable blades in a module may be limited. Some fan designs may require more air movement capability than a single module can provide. Aesthetic considerations may also dictate an increased number of blades in the ceiling fan design.

It is desirable to provide more blades on a retractable blade ceiling fan than the number available from a single module. It is also desirable to increase the air moving capacity of a retractable blade ceiling fan. The ability to provide various numbers of blades to different ceiling fan designs with many common parts would also provide substantial benefits.

In some embodiments, the present invention provides a movable element of a fan housing or blade mounting system to completely hide the blades when not in use. Alternatively one or more elements of the deployable blades, e.g., an upper surface of the blades, or an outer edge of the blades, may be shaped to blend aesthetically into the fan housing while in the blades are in the stowed position (stored position or retracted position). Thus the ceiling fan can be transformed into an attractive lighting fixture or an inconspicuous element of an architectural space when the ceiling fan is not operating to move air. In the case of movable blade concealing elements, movement of the blade concealing elements can be accomplished by an independent motive power source, or by the motive power sources for blade deployment (deployment motors) or overall fan rotation (main drive motor) could be used in a coordinated manner. The independent motive power source could be for example an electric motor, or a hydraulic or pneumatic cylinder. Various mechanical power transmitting means may be provided, such as gears, belts, or cables to transmit motion from the motive power source to each movable concealing element. It is also possible to have a separate motive power source each movable concealing element. For the case of blades that blend into the housing while stowed, trim features may be incorporated into the blades to match visual trim elements of the housing, or the entire blade may be shaped to substantially match the profile of the housing.

It will become apparent that providing active blade concealment will confer a number of advantages. The blades can be substantially hidden from view when not in use. This frees a ceiling fan designer from having to compromise for example between designing a lighting fixture and designing a ceiling fan. The design could be a visually pleasing light fixture with the unexpected ability to move air when needed.

The present invention, in accordance with some embodiments, provides an active deployment mechanism to deploy the blade of the ceiling fan to a fully open position (deployed position) and pitched position. The deployment mechanism is also capable of moving the blade of the ceiling fan to a flat (parallel) stowed position inside the housing. The mechanism is integrated with its own motive power source (deployment motor), which may be an electric motor or solenoid, pneumatic or hydraulic cylinder, or the like. There can as many deployment motors and deployment mechanisms as there are blades on the ceiling fan to be deployed.

It will become apparent that providing a separate deployment motor for each deployment mechanism will confer a number of advantages. For example, economies of scale will be greatly increased while simplifying overall assembly and balancing of the ceiling fan.

The present invention, in accordance with some embodiments, is a powered means of blade deployment and/or retraction. A motive power source is provided to drive the articulation of blades of a ceiling fan independent of fan operating speed or direction. The motive power source could be for example an electric motor or solenoid, or a hydraulic or pneumatic cylinder. The blades could, for example, be mounted on pivots, on linkages or on sliding means, or could employ a telescoping or folding structure whereby the blades are deployed by extending their length or folding either along a hinge across their width (like a clamshell) or across themselves (like a pocket knife). Various mechanical power transmitting means may be provided, such as gears, belts, or cables to transmit motion from the motive power source to each blade. It is also possible to have a separate motive power source for deploying or retracting each blade.

It will become apparent that providing independent powered means for deployment and retraction of ceiling fan blades will confer a number of advantages. This makes it possible to perform the deployment and retraction of the blades while the fan is at rest, i.e., not rotating and/or not moving air. This would result in a visually appealing ceiling fan. An additional advantage is positive (active) positioning of the blades under all operating conditions, thus assuring correct balance and air moving performance. In addition there are a number of advantages in potential blade mounting configurations and storage configurations that are not possible without active blade deployment.

The present invention, in some embodiments, provides a method of employing stacked retractable blade modules in a ceiling fan. Each module defines a substantially planar arrangement of blades. The module may have one or more motive power sources on board for blade deployment and retraction. In another configuration, an external motive power source may provide blade deployment and retraction for one or more of the stacked modules.

It will become apparent that providing stacked compact planar deployable blade modules will confer a number of advantages. An arbitrary number of blades may be incorporated into a retractable blade ceiling fan design with minimal package space. This provides the designer with optimum flexibility. The use of modules with many common parts and stacking them to vary the number of blades can provide substantial economies of scale in the production of different ceiling fan designs.

The advantages of the present invention in various embodiments include, without limitation, improved means for concealing the blades of a deployable blade ceiling fan when not in use. One or more elements of the fan housing may be moved into position to obscure the blades or the blade support structure may be moved to obscure the blades relative to the fan housing. Alternatively certain decorative elements of the fan blades may be designed to match elements of the housing while the blades are in a stored position. The shape of the fan blades may also be configured to substantially match the shape of one or more housing elements. Thus the fan may be designed as an attractive architectural element or lighting fixture for a space without compromising the functions of having exposed fan blades. An additional advantage of the invention is the ability to provide a pleasing visual metamorphosis for the user as, for example, the lighting fixture transforms itself into a fan and moves air.

In broad embodiment, the present invention is a means of utilizing movable elements of a ceiling fan housing or blade support structure to hide the blades when they are folded to a storage position. The motive power source for the movable housing elements may be independent of the main motive power source that rotates the fan assembly in operation or the motive power source that deploys and retracts the blades. Alternatively elements of the movable blades may be designed to blend or match elements of the fan housings to conceal the blades while in a storage position. The blade elements may be decorative or the blade shape may be configured to substantially match the shape of one or more housing elements.

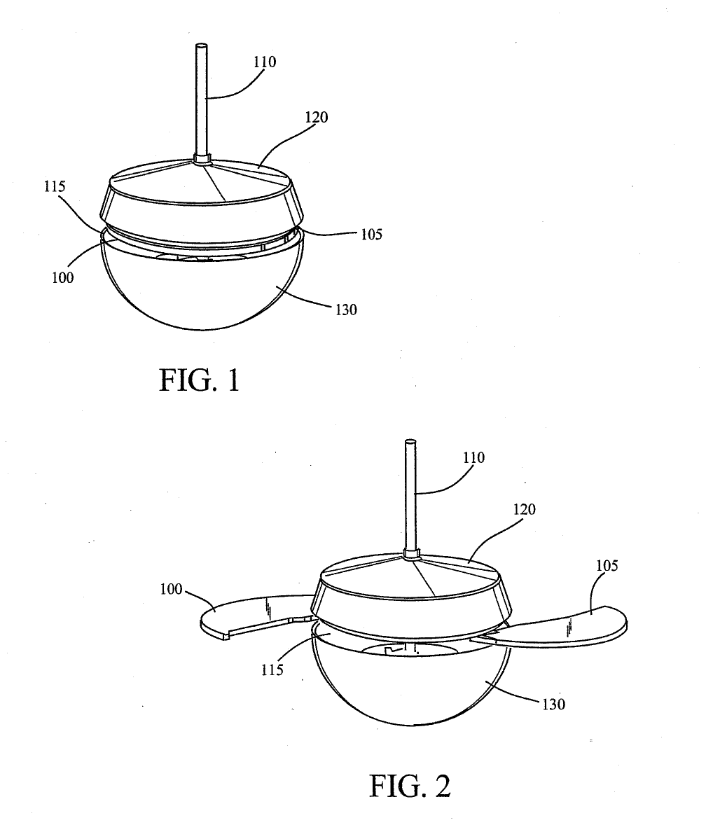

Referring to FIG. 1, a perspective view is shown of a ceiling fan in accordance with one embodiment of the present invention showing a plurality of actively deployable fan blades 100 and 105 in a stowed (or stored position). Shown is a support pole (or rod) 110, an upper housing 120, a light cover 130, a first blade shown in a stowed position 100, and a second blade 105 in the stowed position.

The support pole (or rod) 110, made of a material such as steel, aluminum, wood, plastic, composite materials (such as composites contacting polyester, vinyl ester, epoxy, phenolic, polyimide, polyamide, polypropylene, PEEK, metals, and/or others, with fibrous materials or ground minerals, wood, paper, textiles, and/or others), is coupled at a distal end to a mounting surface, such as a ceiling of a room (not shown). The support pole (or rod) 110 is coupled at a proximal end to the upper housing. The upper housing 120 encloses a main drive shaft (not shown), a main drive motor (not shown), and a deck (not shown) made from, e.g., aluminum, zinc or steel (i.e., metal castings or stampings), plastic, composites, wood, such as polycarbonate, which is turned about a main axis defined by the support pole (or downrod) 110, the main drive shaft and the main drive motor in response to actuation of the main drive motor, such as by the application of power to the main drive motor by the activation of a wall switch or control (or, alternatively, wired or wireless remote control) (not shown), such as is known in the art.

In lieu of the support pole, or downrod, alternative mounting mechanisms may be used. For example, Some fans mount using a “ball-and-socket” system. With this system, there is a metal or plastic hemisphere mounted on the end of the downrod; this hemisphere rests in a ceiling-mounted metal bracket and allows the fan to move freely (which is very useful on vaulted ceilings, for example). Other Some fans mount using a “J-hook” (also known as a “claw-hook”) system. In accordance with the “J-hook: system, a metal hook secures to a ceiling-mounted metal bolt. Generally, a rubber bushing is inserted between the hook and the bolt to reduce noise. Yet other fans can be mounted using a Low-Ceiling Adapter, a special kit that eliminates the need for a support pole, or downrod, and is therefore useful in rooms with low ceiling clearance. Finally, canopy (ceiling cover piece) can optionally be screwed directly into the top of the motor housing; then the whole fan can be secured directly onto the ceiling mounting bracket. This is known as a “close-to-ceiling” mount.

The deployment mechanism and the deployment motor must be smooth, quiet, durable, and reliable. If one blade fails to deploy it can cause serious imbalance problems when the main drive motor starts up. Thus it is imperative to specify a high quality motor for the deployment motors described herein.

The type most suitable for the described embodiments is a DC gearmotor. This type of deployment motor is very powerful and durable, and can be made acceptably quiet with careful design of the mechanism and mounting. The low voltage DC power required by the DC gearmotor is made safe in many environments, including high humidity and outdoors. The life of the motor is equivalent to many years of service in a fan at high reliability.

Alternatively, the AC synchronous gearmotor is suitable as well. These tend to be lower in torque than the DC gearmotors, but they are absolutely silent in operation. The silence can be advantageous, but the durability tends to be less than the DC motor, and the full 120V AC current used to supply the AC synchronous gearmotor can be less safe in certain wet or humid environments. The AC synchronous gearmotors tend to be short and wide, whereas the DC gearmotors tend to be thin and long. The thin, long form factor provides a more advantageous package in a wider variety of fan designs than a short, wide form factor.

For the above reasons, the DC gearmotor is preferred in the embodiments described in this specification.

It should be clear that the deployment motor is preferably a substantial, industrial quality motor. The fan blades can be quite heavy and the mechanism (with its motor) must be able to resist large loads, such as a blade colliding with something during operation, or a user bumping into a blade or twisting a blade when it is deployed. In addition, the mechanism and motor must resist substantial aerodynamic and centrifugal loads that may occur when the fan is, for example, running at high speeds. The motor and mechanism must maintain precise blade position to ensure balance and optimal air moving performance.

As the deck is turned (or rotated) a pair of blades 100 and 105, made from, e.g., MDF, plywood, aluminum, steel, plastic, composite materials (such as those listed above), wicker, fabric wrapped metal, wooden or plastic frames, or the like affixed thereto is likewise rotated. Note that, as shown the main drive shaft does not rotate relative to the support pole 110 (or the room or space in which the ceiling fan is utilized). Instead the main drive motor rotates about the main drive shaft, and thus rotates relative to the support pole 110, and the room or space in which the ceiling fan is utilized. The main drive motor is fixed in position, in accordance with the present embodiment, relative to the deck, and thus, the rotation of the main drive motor relative to the main drive shaft results in rotation of the deck (and the blades affixed thereto) relative to the main drive shaft, and the room, or space in which the ceiling fan is utilized.

Prior to rotation of the deck (not shown), the blades 100 and 105 may be are deployed into a position so as to facilitate the movement of air in response to the rotation of the blades 100 and 105. Preferably however, the blades 100 and 105 may be deployed as the rotation of the deck begins, so as to create a smooth, aesthetic appearance, and to assist in the stabilization of the blades as the blades are deployed, i.e., to assist with the elimination of “wobble” in the blades as they are deployed. In accordance with the present embodiment, a light, such as an incandescent light bulb or an light emitting diode array, are positioned below the deck and affixed to a main shaft, made from, for example steel or the like, that is coaxial with the support pole 110, so as to fix the light below the deck, and such that the light does not rotate in response to the turning of the main drive motor. The light cover encloses the light, providing a measure of protection from, for example, dust, weather, or the like, and providing safety and aesthetically pleasing structure for the ceiling fan.

Alternatively, a lower fan housing element (which may be made from, e.g., glass, steel, aluminum, alabaster, fiberglass, carbon fiber, plastics, ceramics, clays) may be used in lieu of the light cover 130, in the event, in accordance with other embodiments, the light is not utilized. In such alternative embodiment the ceiling fan serves the single function of air movement, and does not serve as a light fixture.

A gap 115 is defined between the upper housing 120 and the light cover 130 (or lower housing) (which may be made from, e.g., glass, steel, aluminum, alabaster, fiberglass, carbon fiber, plastics, ceramics, clays) through which the blades 100 and 105 are deployed, for example, upon actuation. The gap 115 should be no wider than necessary to accommodate passage of the blades 100 and 105 into their deployed position while co-planar and parallel to one another. In a variation, the gap 115 may be closed once the blades 100 and 105 reach a retracted position (in response to deactivation of the ceiling fan). Such closing of the gap may be achieved by moving the light cover 130 (or lower housing), relative to the upper housing 120, so as to close the gap 115. This may be, for example, expected by the movement of the light cover 130 in a generally upward direction (toward the ceiling) under the influence of a motive device, such as a motor, solenoid, a hydraulic cylinder, a pneumatic cylinder, or the like.

Referring to FIG. 2, a perspective view is shown of the ceiling fan in accordance with the embodiment of FIG. 1 showing the plurality of actively deployable fan blades 100 and 105 in a partially deployed (or use position). Shown is the support pole 110, the upper housing 120, the light cover 130, the first blade 100 shown in a partially deployed position, and the second blade 105 showed in a partially deployed position.

The support pole (or rod) 110 is coupled at a distal end to the mounting surface, such as a ceiling of a room (not shown). The support pole (or rod) 110 is coupled at a proximal end to the upper housing 120. The upper housing 120 encloses a main drive shaft (not shown), a main drive motor (not shown), and a deck (not shown), which is turned about a main axis defined by the support pole, the main drive shaft and the main drive motor in response to actuation of the main drive motor, such as by the application of power to the main drive motor by the activation of a wall switch (not shown), such as is known in the art. As the deck is turned (or rotated) the pair of blades 100 and 105 affixed thereto is likewise rotated.

Prior to rotation of the deck, the blades 100 and 105 may be deployed into a position so as to facilitate the movement of air in response to the rotation of the blades 100 and 105. Preferably however, the blades 100 and 105 may be deployed as the rotation of the deck begins, so as to create a smooth, aesthetic appearance, and to assist in the stabilization of the blades as the blades are deployed, i.e., to assist with the elimination of “wobble” in the blades as they are deployed. This deployment includes both rotation of the blades 100 and 105 about an axis parallel to the main axis (but not coaxial therewith), so as to move the blades 100 and 105 from a stowed position to a deployed position, and the rotation of the blades 100 and 105 about an axis substantially perpendicular (or otherwise not parallel (or otherwise off parallel, i.e., otherwise rotated to a position in a plane that is off perpendicular to the axis of rotation of the blades as they are rotated by the main drive motor about the main drive shaft) to the main axis, so as to alter the pitch of the blades 100, e.g., from 10 degrees to 30 degrees and 105 in order to facilitate movement of air by the blades 100 and 105 upon rotation of the blades 100 and 105 about the main axis.

Advantageously, in accordance with the teachings herein the pitch of the blades 100 may be reversed in response to a control signal, such as from a wall control, or a wired or wireless remote control, so as to control the deployment motors to reverse the pitch of the blades, e.g., from, for example, +10 degrees to +30 degrees relative to horizontal, to from, for example, −10 degrees to −30 degrees. In this way, the direction of air movement caused in response to the turning of the main drive motor can be reversed without changing the direction of rotation of the main drive motor.

In accordance with the present embodiment, a light, such as an incandescent light bulb or a light emitting diode array, is positioned below the deck and affixed to the drive shaft, which is coaxial with the support pole 110, so as to fix the light below the deck such that the light does not rotate in response to the turning of the main drive motor. The light cover 130 encloses the light, providing a measure of protection from, for example, dust, weather, or the like, and providing safety and aesthetically pleasing structures for the ceiling fan.

Alternatively, a lower fan housing element (not shown) may be used in lieu of the light cover 130, in the event, in accordance with other embodiments, the light is not utilized. In accordance with this embodiment, in order provide lighting, an uptight may be used at the base of the upper fan housing element, or an external (outside of the lower housing) light may be used at the base of the lower housing, or, in the event no lighting is incorporated in the to the ceiling fan, a light may not be used at all.

A gap 115 is defined between the upper housing 120 and the light cover 130 (or lower housing) through which the blades 100 and 105 are deployed, for example, upon actuation. In accordance with one embodiment, this deployment is initiated and completed before the application of power to the main drive motor. The gap 115 should be no wider than necessary to accommodate passage of the blades 100 and 105 into their deployed position while co-planar and parallel to one another. (Preferably the alteration of the pitch of the blades 100 and 105 occurs during deployment of the blades 100 and 105, after the blades 100 and 105 have passed through the gap 115 to a position outside the upper housing 120, and the light cover 130.)

In a variation, the gap 115 may be closed once the blades 100 and 105 reach a retracted position (in response to deactivation of the ceiling fan, with preferably such retraction being initiated upon the ceasing of movement of the deck about the main drive shaft). Such closing of the gap 115 may be achieved by moving the light cover 130 (or lower housing), relative to the upper housing 120, so as to close the gap 115. This may be, for example, be effected by the movement of the light cover 130 (or lower housing) in a generally upward direction (toward the ceiling) under the influence of a motive device, such as a motor, solenoid, a hydraulic cylinder, a pneumatic cylinder, or the like.

In a further alternative embodiment, the upper housing 120 moves away from the ceiling, so as to close the gap 115, or a combination of movement of the upper housing 120 away from the ceiling, and movement of the light cover 130 (or lower housing) toward the ceiling may be employed to achieve closure of the gap 115.

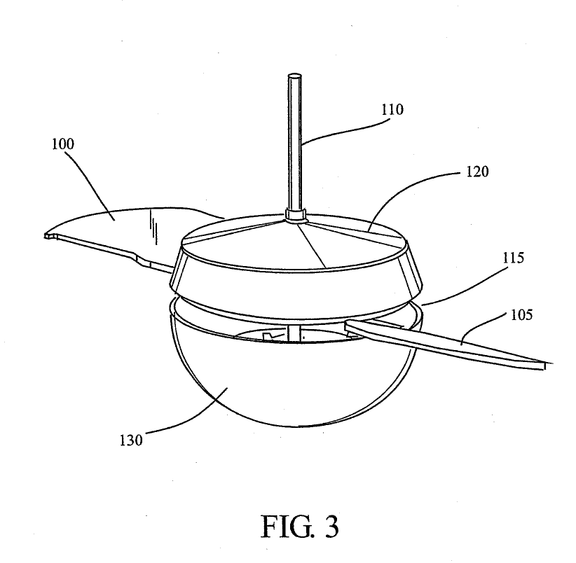

Referring to FIG. 3, a perspective view is shown of the ceiling fan in accordance with the embodiment of FIGS. 1 and 2 showing the plurality of actively deployable fan blades 100 and 105 in a deployed (or use) position, and having their pitch altered for air movement. Shown is the support pole (or rod) 110, the upper housing 120, the light cover 130, the first blade shown 100 in a deployed position, and the second blade 105 showed in a deployed position.

The support pole (or rod) 110 is coupled at a distal end to the mounting surface, such as a ceiling of a room (not shown). The support pole (or rod) 110 is coupled at a proximal end to the upper housing 120. The upper housing 120 encloses a main drive shaft (not shown), a main drive motor (not shown), and a deck (not shown), which is turned about a main axis defined by the support pole (or rod) 110, the main drive shaft and the main drive motor in response to actuation of the main drive motor, such as by the application of power to the main drive motor by the activation of a wall switch (not shown), such as is known in the art. As the deck is turned (or rotated) the pair of blades 100 and 105 affixed thereto is likewise rotated.

Prior to rotation of the deck, the blades 100 and 105 may be deployed into a position so as to facilitate the movement of air in response to the rotation of the blades 100 and 105 Preferably however, the blades 100 and 105 may be deployed as the rotation of the deck begins, so as to create a smooth, aesthetic appearance, and to assist in the stabilization of the blades as the blades are deployed, i.e., to assist with the elimination of “wobble” in the blades as they are deployed. This deployment includes both rotation of the blades 100 and 105 about an axis parallel to the main axis (but not coaxial therewith), so as to move the blades from a stowed position to a deployed position, and the rotation of the blades about an axis substantially perpendicular (or otherwise not parallel (or otherwise off parallel, i.e., otherwise rotated to a position in a plane that is off perpendicular to the axis of rotation of the blades as they are rotated by the main drive motor about the main drive shaft) to the main axis (such as normal to the main axis), so as to alter the pitch of the blades 100 and 105 in order to facilitate movement of air by the blades 100 and 105 upon rotation of the blades 100 and 105 about the main axis. Alternatively, the blades 100 and 105 may slide radially (relative to the main axis) along a linear path into the deployed position, may slide radially and tangentially (relative to the main axis) along a linear path into the deployed position, or may move along a path defined by radial, tangential, and rotational paths, e.g., a non-linear path.

In any case, the blades 100 and 105 are preferably rotated about an axis substantially perpendicular (or otherwise off parallel, i.e., otherwise rotated to a position in a plane that is off perpendicular to the axis of rotation of the blades as they are rotated by the main drive motor about the main drive shaft) to the main axis, so as to alter the pitch of the blades 100 and 105 in order to facilitate movement of air by the blades 100 and 105 upon rotation of the blades 100 and 105 about the main axis. The path is selected in accordance with the optimal placement of the blades 100 and 105 for air movement, the shape of the blades 100 and 105, and the shape and size of the housing, as well as aesthetic factors. In accordance with the present embodiment, a light, such as an incandescent light bulb or a light emitting diode array, is positioned below the deck and affixed to the drive shaft, which is coaxial with the support pole (or rod) 110, so as to fix the light below the deck such that the light does not rotate in response to the turning of the main drive motor. The light cover 130 encloses the light, providing a measure of protection from, for example, dust, weather, or the like, and providing safety and aesthetically pleasing structures for the ceiling fan.

Alternatively, a lower housing element may be used in lieu of the light cover 130, in the event, in accordance with other embodiments, the light is not utilized. In such alternative embodiment the ceiling fan serves the single function of air movement, and does not serve as a light fixture.

A gap 115 is defined between the upper housing 120 and the light cover 130 (or lower housing) through which the blades 100 and 105 are deployed, for example, upon actuation. In accordance with one embodiment, this deployment is initiated and completed before the application of power to the main drive motor. The gap 115 should be no wider than necessary to accommodate passage of the blades 100 and 105 into their deployed position while co-planar and parallel to one another. (Preferably the alteration of the pitch of the blades 100 and 105 occurs during deployment of the blades 100 and 105, after the blades 100 and 105 have passed through the gap 115 to a position outside the upper housing 120, and the light cover 130.)

In an alternative, the pitch of the blades 100 and 105 may be fixed, with the gap 115 and the path being selected to permit deployment of the pre-pitched blades 100 and 105 into their deployed position.

In a variation, the gap 115 may be closed once the blades 100 and 105 reach a retracted position (in response to deactivation of the ceiling fan, with preferably such retraction being initiated upon the ceasing of movement of the deck about the main drive shaft). Such closing of the gap 115 may be achieved by moving the light cover 130, relative to the upper housing 120, so as to close the gap 115. This may be, for example, be effected by the movement of the light cover 130 in a generally upward direction (toward the ceiling) under the influence of a motive device, such as a motor, solenoid, a hydraulic cylinder, a pneumatic cylinder, or the like.

In a further alternative embodiment, the upper housing 120 moves away from the ceiling, so as to close the gap 115, or a combination of movement of the upper housing 120 away from the ceiling, and movement of the light cover 130 toward the ceiling may be employed to achieve closure of the gap 115.

Retraction of the blades 100 and 105 from the deployed position to the stowed position is effected by adjusting the pitch of the blades 100 and 105 so as to be co-planar and parallel to one another (assuming variable pitch), rotating (or otherwise moving the blades 100 and 105 along a reverse path of the path used to deploy the blades 100 and 105, so as to move the blades 100 and 105 through the gap 115 into the stowed position, and, optionally, closing the gap 115 by moving the upper housing 120 and/or the light cover 130 relative to one another, so as to close the gap 115.

Preferably the blades 100 and 105 are even in number, for example, two or four, however, there could be other numbers of blades in other embodiments of the invention, such as odd numbers of, e.g. 3 or 5.

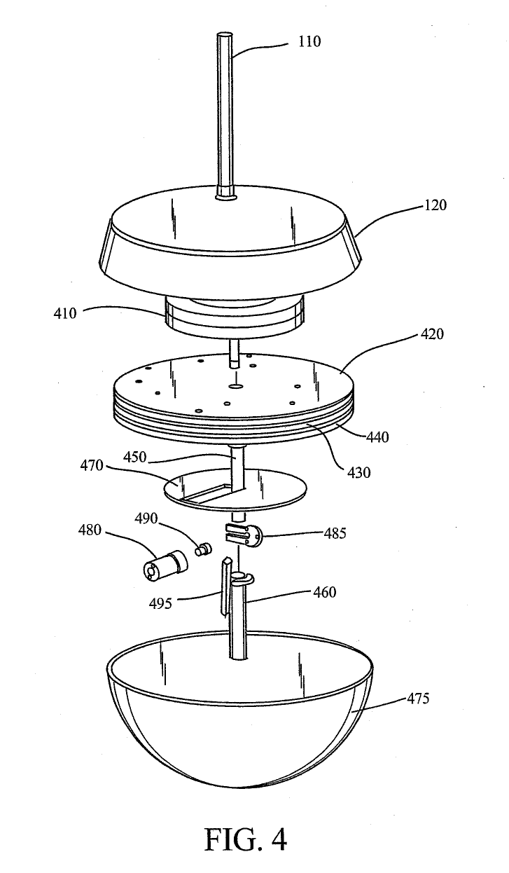

Referring next to FIG. 4, shown are a support pole 110, an upper housing 120, a main drive motor 410, a first (upper) deck 420, a fan blade 430 (in a stowed position), a second (lower) deck 440, a main drive shaft 450, a main drive shaft sleeve 460, a plate 470, a light cover 475, a light cover deployment motor 480, a light cover deployment motor mount 485, a light cover deployment pinion 490, and a light cover deployment rack 495.

The exploded view of FIG. 4 shows the internal components necessary to effect the positioning of the movable light cover 475 (or housing element) of one embodiment of the present invention. A fan blade 430 is movably affixed to a first (upper) deck 420 and a second (lower) deck 440. The fan blade 430 and the first (upper) deck 420 and the second (lower) deck 440 are rotated as an assembly by the main drive motor 410 during normal ceiling fan operation. The main drive motor 410 is supported by the support pole 110 from the ceiling fan mounting point, on the ceiling of a room or space (not shown).

The movable light cover 475 (or housing element—which may or may not be transmissive to light, as the ceiling fan may, in some embodiments, include a light, and in other embodiments may not include a light) is rigidly connected to the main drive shaft sleeve 460, which is coaxial with the main drive shaft 450. The main drive shaft sleeve 460 is rigidly connected to the plate 470. A light cover deployment motor 480 is also rigidly mounted to the plate 470 by means of a light cover deployment motor mount 485.

The main drive shaft sleeve 460 is slidably mounted to the main drive shaft 450. The rack 495 is rigidly attached to the main drive shaft 450, and passes through a slot (not shown) along the length of the main drive shaft sleeve 460, so that the teeth of the rack 495 may extend beyond the outer diameter of the sleeve main drive shaft 460. This serves two purposes: first, this allows the light cover deployment motor 480 and the light cover deployment pinion 490 to engage a stationary reference (the light cover deployment rack 495) so they may move relative to the main drive shaft 450 and main drive motor 410, second, the side walls of the light cover deployment rack 495 are in close proximity to the walls of the slot (not shown) of the main drive shaft sleeve 460 thereby restricting the main drive shaft sleeve 460 from rotating about the main drive shaft 450 (thus the light cover 475 cannot rotate at all). The light cover deployment motor 480 turns the light cover deployment pinion 490 to climb up and down relative to light cover deployment rack 495. Since the plate 470, the sleeve 460, and the light cover 475 are rigidly connected to the light cover deployment motor 480 and the light cover deployment pinion 490, the plate 470, the light cover deployment motor mount 485, the main drive shaft sleeve 460, and light cover 475 all move together as one assembly up and down relative to the light cover deployment rack 495.

Note that it is possible, but not preferable to stop the housing deployment motor at a midpoint of travel. It is much simpler to run the motor to hard stops at either end and have the control module detect a high current spike from the motor stalling. This current spike tells the controller that the motor has reached the end of travel.

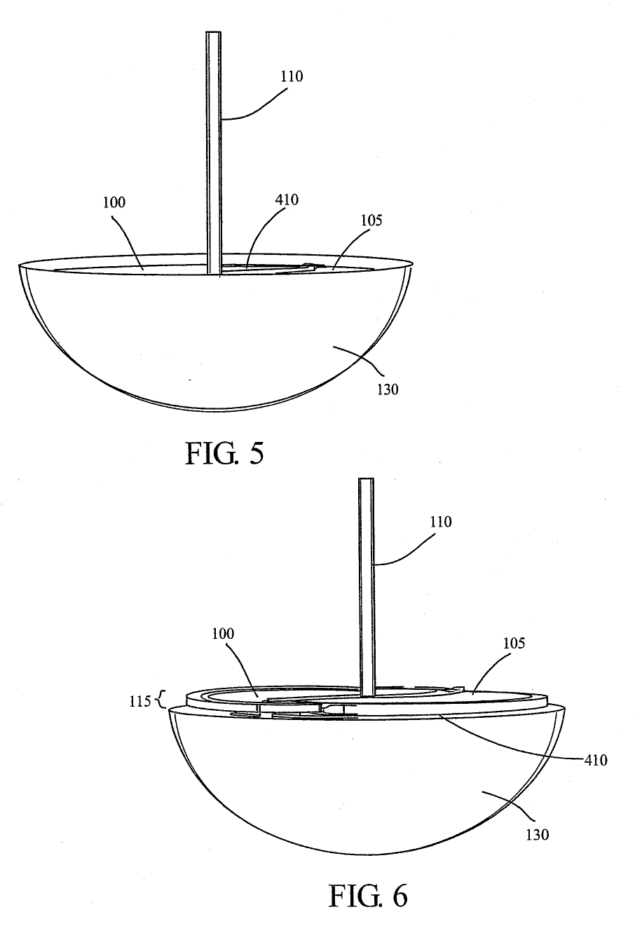

Referring next to FIG. 5, a perspective view is shown of a a ceiling fan in accordance with the present invention, varying from the embodiment shown in FIG. 1, showing the plurality of actively deployable fan blades 100 and 105 in a stowed (or stored) position, and a light cover 130 in a stowed (or stored) position. Shown is a support pole (or rod) 110, a light cover 130, and a deck 420. The light cover 130 is shown in a stowed position, i.e., a raised position, whereby the deck 420 is concealed below an upper edge of the light cover 130. As can be seen, aesthetic appeal of the fixture is achieved by the concealment of the deck 420 below the upper edge of the light cover 130 when blades 100 and 105 of the ceiling fan, which are coupled to the deck 420, are in a stored position, when the fixture is viewed from a position generally below the upper edge of the light cover 130, as would typically be the case in most installations of the fixture.

The support pole (or rod) 110 is fixed at a distal end to a ceiling (not shown), and at a proximal end to a main drive shaft (not shown) concealed behind the light cover 130.

Referring next to FIG. 6, a perspective view is shown of a ceiling fan in accordance with the embodiment of FIG. 4, showing the plurality of actively deployable fan blades 100 and 105 in a stowed (or stored) position, and the light cover 130 in a deployed (or use) position. Shown are the support pole (or rod) 110, the light cover 130, and the deck 420. The light cover 130 is shown in a lowered position, i.e., a deployed position, whereby the deck 420 is exposed above the upper edge of the light cover 130 sufficient to allow the deployment of the blades 100 and 105 from the deck 420. Preferably, the lowering of the light cover 130 is only to the degree necessary to facilitate deployment of the blades 100 and 105, whereby maximum aesthetic appeal is maintained during and after deployment of the blades 100 and 105.

This support pole (or rod) 110 is fixed at a distal end to a ceiling (not shown), and at a proximal end to a main drive shaft concealed behind the light cover 130.

Upon actuation of the fixture (the ceiling fan), a motor is actuated, such as an electric motor, a solenoid, a hydraulic cylinder, a pneumatic cylinder, or the like, so as to lower the light cover 130 sufficient to allow deployment of the blades 100 and 105 from the deck 420 over the upper edge of the light cover 130.

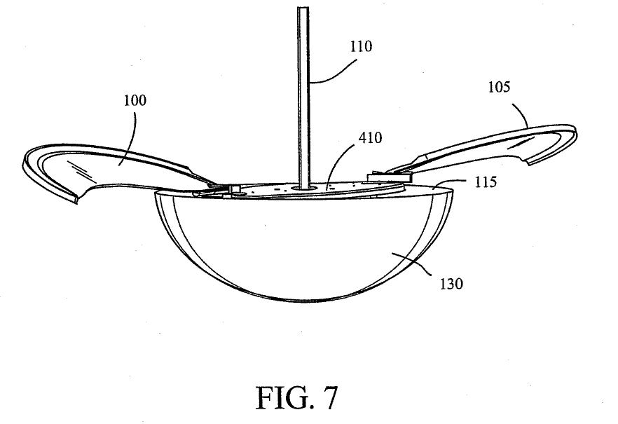

Referring next to FIG. 7, a perspective view is shown of a ceiling fan in accordance with the embodiment of FIGS. 4 and 5 showing the plurality of actively deployable fan blades 100 and 105 in a deployed (or use) position, and having their pitch altered for air movement. Shown is the support pole (or rod) 110, a light cover 130, and a deck 420. A light cover 130 is shown in the lowered position, i.e., a deployed position, whereby the deck 420 is exposed above the upper edge of the light cover 130 sufficient to allow the deployment of the blades 100 and 105 from the deck 420. Preferably, the lowering of the light cover 130 is only to the degree necessary to facilitate deployment of the blades 100 and 105, whereby maximum aesthetic appeal is maintained during and after deployment of the blades 100 and 105.

As can be seen, the blades 100 and 105 are each rotated away from the deck 420 along a respective axis (a separate deployment axis for each blade) substantially parallel to but not coaxial with a main axis of the ceiling fan, as defined by the support pole (or rod) 110, and a main drive shaft of the ceiling fan (not shown). In addition, the blades 100 and 105 are each further rotated into a pitched position along an axis (a separate pitching axis for each blade 100 and 105) that is substantially normal to the main axis of the ceiling fan (and the deployment axis of the blade). This positions the blades 100 and 105 for movement of air upon rotation of the blades 100 and 105 about the main axis (all blades 100 and 105 are simultaneously rotated about the main axis as the deck 420 is rotated about the main axis under the influence of the main drive motor affixed thereto) under the influence of a main drive motor (not shown). The main drive motor imparts a relative rotational movement about the main axis between the deck 420 and the blades 100 and 105 affixed thereto by deployment mechanisms and the main drive shaft to which the support pole, and the light cover 130 are affixed, Preferably, deployment of the blades 100 and 105 occurs before the blades 100 and 105 are rotated about the main axis under the influence of the main drive motor, including rotation of the blades 100 and 105 about their respective pitching axes.

Retraction of the blades 100 and 105 from the deployed position to the stowed position is effected by adjusting the pitch of the blades 100 and 105 so as to be co-planar and parallel to one another (assuming variable pitch), rotating (or otherwise moving the blades 100 and 105 along a reverse path of the path used to deploy the blades 100 and 105, so as to move the blades 100 and 105 through the gap 115 into the stowed position, and, optionally, closing the gap 115 by moving the upper housing and/or the light cover 130 relative to one another, so as to close the gap 115.

Alternatively, the blades 100 and 105 may slide radially (relative to the main axis) along a linear path into the deployed position, or may slide radially and tangentially (relative to the main axis) along a linear path into the deployed position, or may move along a path defined by radial, tangential, and rotational paths, e.g., a non-linear path. In any case, the blades 100 and 105 are preferably rotated about an axis perpendicular to the main axis, so as to alter the pitch of the blades 100 and 105 in order to facilitate movement of air by the blades 100 and 105 upon rotation of the blades 100 and 105 about the main axis. The path is selected in accordance with the optimal placement of the blades 100 and 105 for air movement, the shape of the blades 100 and 105, and the shape and size of the housing, as well as aesthetic factors.

In accordance with the present embodiment, a light, such as an incandescent light bulb or a light emitting diode array, are positioned below the deck 420 and affixed to a main shaft (not shown), that is coaxial with the support pole (or rod) 110, so as to fix the light below the deck 420 such that the light does not rotate in response to the turning of the main drive motor. The light cover 130 encloses the light, providing a measure of protection from, for example, dust, weather, or the like, and providing safety and aesthetically pleasing structures for the ceiling fan. Alternatively, a lower fan housing element may be used in lieu of the light cover 130, in the event, in accordance with other embodiments, the light is not utilized. In such alternative embodiment the ceiling fan serves the single function of air movement, and does not serve as a light fixture.

In variations of the present embodiment, the blade support structure or housing elements need not move in order to conceal the blades 100 and 105. The blades 100 and 105 themselves are designed to blend into the housing while in the stowed position.

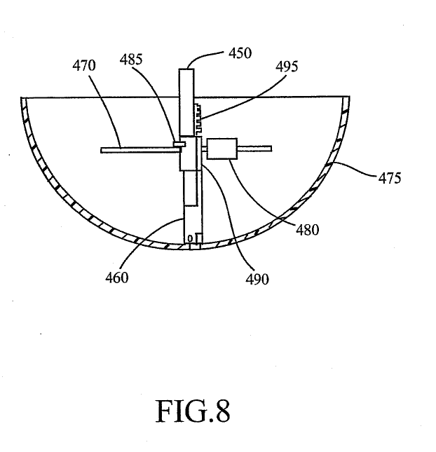

Referring next to FIG. 8, an axial translation of the plate 470, main drive shaft sleeve 460 and light cover 475 (or lower housing) is accomplished relative to the main drive shaft 450 by means of the light cover deployment pinion 490 engaging the light cover deployment rack 495. The light cover deployment rack 495 is rigidly mounted to the main drive shaft 450 and does not rotate or translate during normal ceiling fan operation. The light cover deployment pinion 490 is driven by the light cover deployment motor 480 and thus causes the light cover deployment motor 480 to translate relative to the light cover deployment rack 495 that is stationary. Since the plate 470 is rigidly connected to the light cover deployment motor 480 via the light cover deployment motor mount 485, and the main drive shaft sleeve 460 is rigidly connected to the plate 470, the main drive shaft sleeve 460, the light cover deployment motor 480, and the light cover deployment motor mount 485, the light cover 475 (or lower housing) will thus translate relative to the main drive shaft 450, the upper and lower decks (not shown), the blades (not shown), the main drive motor (not shown), and the support rod (not shown) when the light cover deployment motor 480 turns in response to power being applied to the light cover deployment motor 480.

In one preferred embodiment, an electrical signal is sent to the light cover deployment motor. Electrical signals are provided by the main controller module (not shown), usually located in the top non-rotating portion of the fan since there is no relative rotational motion, electrical wires may be easily passed through the hollow drive shaft (not shown) of the main drive motor 410 and the main drive shaft 450 that is hollow. Since the travel of the housing displacement system is limited to only what's necessary for the blades to clear the gap, it is sufficient to only provide some extra length of wire, in a loop or arch, to connect to the light cover deployment motor 480. The small translational motion, on the order of an inch or two, can easily be handled by a loop of wire flexing.

This will cause movable housing support structure 470, 480, 460, and 475 to climb or descend relative to the light cover deployment rack 495. The effect of this relative movement is to cause light cover 475 (or lower housing) to open or close a gap 115 relative to the upper housing (not shown). Control of this gap (not shown) between the upper housing and the light cover 475 (or lower housing) is that the blades are allowed to deploy to a deployed position for normal ceiling fan operation through the gap 115 or to be completely hidden from view (by the closing of the gap) while in the stowed position (or storage position) inside the housing. In the preferred embodiment the electrical signals sent to the light cover deployment motor 480 is coordinated with the operation of the main drive motor and the operation of the blade deployment motors (not shown), so no direct user intervention is required to move the light cover 475.

In one preferred embodiment, the light cover 475 is translucent and allows light to pass through from a light device (such as an incandescent light bulb or a light emitting diode array) mounted to the plate 470. In another embodiment the lower housing is employed instead of the light cover 130 and is opaque and may be styled to match or compliment the upper housing.

Other embodiments may have one or more movable housings mounted above or below the blades. As will be appreciated by one of ordinary skill in the art based on the description herein, the fan blades may be covered and uncovered, e.g., the gap 115 opened and closed, by means of axial translation, rotation, or combination movements of the movable housing elements.

Advantages of the present embodiment may include, without limitation, an improved means for hiding the blades of a deployable blade ceiling fan when not in use. By means of a motive power source, an element of the fan housing may be moved into position to completely cover the blades in the storage position. Thus the fan may be designed as an attractive architectural element or lighting fixture for a space without the compromise of exposed fan blades. An additional advantage of the invention is the ability to provide a pleasing visual metamorphosis for the user as, for example, the lighting fixture transforms itself into a fan and moves air.

In one embodiment, the present invention is a means of utilizing movable elements of ceiling fan housing to hide the blades when they are folded to a storage position. The motive power source for the movable housing elements may be independent of the main motive power source that rotates the fan assembly in operation or the motive power source that deploys and retracts the blades.

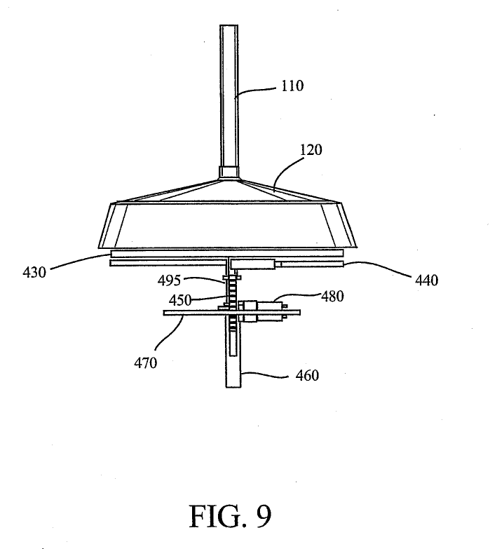

Referring next to FIG. 9, a support pole 110, an upper housing 120, a second (lower) deck 440, a main drive shaft 450, a main drive shaft sleeve 460, a plate 470, a light cover deployment motor 480, a light cover deployment motor mount 485, a light cover deployment pinion 490, and a light cover deployment rack 495.

For a description of what is shown in FIG. 9, reference should be made to the detailed description made above in reference to FIG. 4-8.

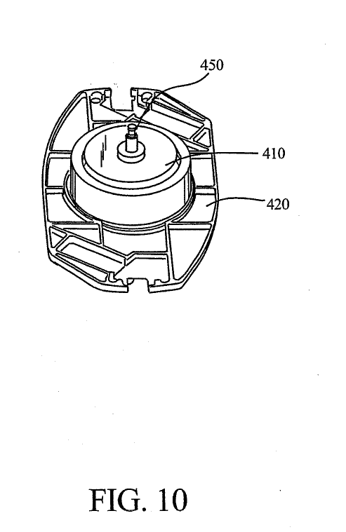

Referring next to FIG. 10, a top perspective view of a ceiling fan in accordance with the embodiment of FIGS. 4-9, showing the first (upper) deck 420, the main drive motor 410, and a top portion of the main drive shaft 450 of the embodiment of FIG. 4.

For a description of what is shown in FIG. 10, reference should be made to the detailed description made above in reference to FIG. 4-9.

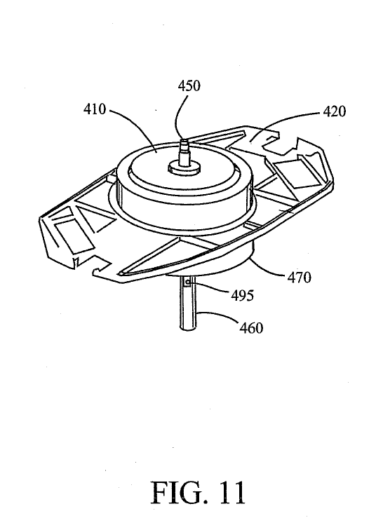

Referring next to FIG. 11, a side perspective view of a ceiling fan in accordance with the embodiment of FIGS. 4-10, showing the first (upper) deck 420, the main drive motor 410, a top portion of the main drive shaft 450, the main drive shaft sleeve 460, the plate 470, and the light cover deployment rack 495.

For a description of what is shown in FIG. 11, reference should be made to the detailed description made above in reference to FIG. 4-10.

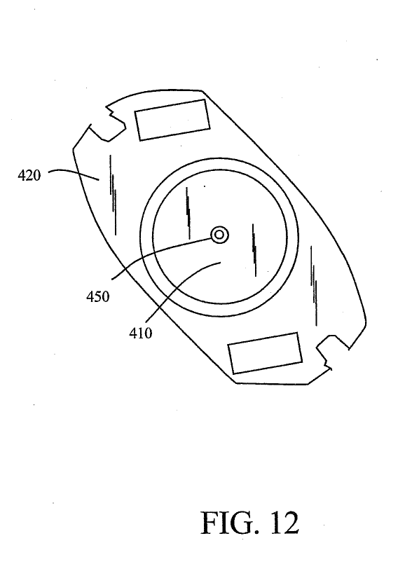

Referring next to FIG. 12, a top plan view of a ceiling fan in accordance with the embodiment of FIGS. 4-11, showing the first (upper) deck 420, the main drive motor 410, and a top portion of the main drive shaft 450.

For a description of what is shown in FIG. 12, reference should be made to the detailed description made above in reference to FIG. 4-11.

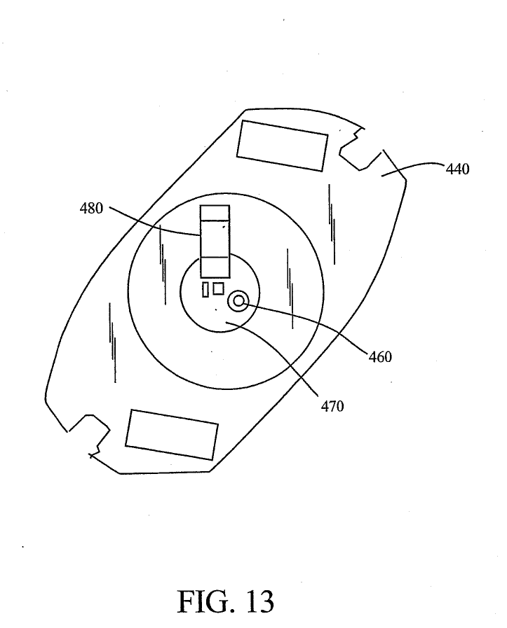

Referring next to FIG. 13, a bottom plan view of a ceiling fan in accordance with the embodiment of FIGS. 4-12, showing a second (lower) deck 440, a main drive shaft sleeve 460, a plate 470, and a light cover deployment motor 480.

For a description of what is shown in FIG. 13, reference should be made to the detailed description made above in reference to FIG. 4-12.

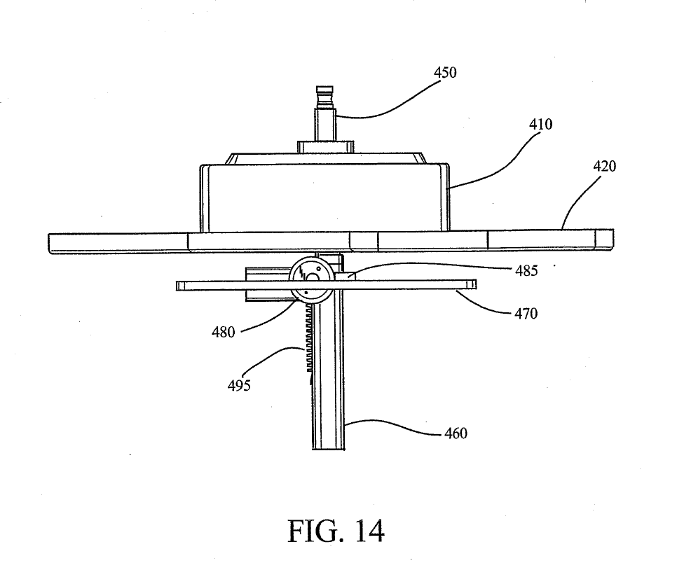

Referring next to FIG. 14, a side view of a ceiling fan in accordance with the embodiment of FIGS. 4-13, showing a main drive motor 410, a first (upper) deck 420, a main drive shaft 450, a main drive shaft sleeve 460, a plate 470, a light cover deployment motor 480, a light cover deployment motor mount 485, and a light cover deployment rack 495. The light cover deployment motor 480 is in a position that has closed the gap 115 between the upper housing (not shown) and the light cover (not shown).

For a description of what is shown in FIG. 14, reference should be made to the detailed description made above in reference to FIG. 4-13.

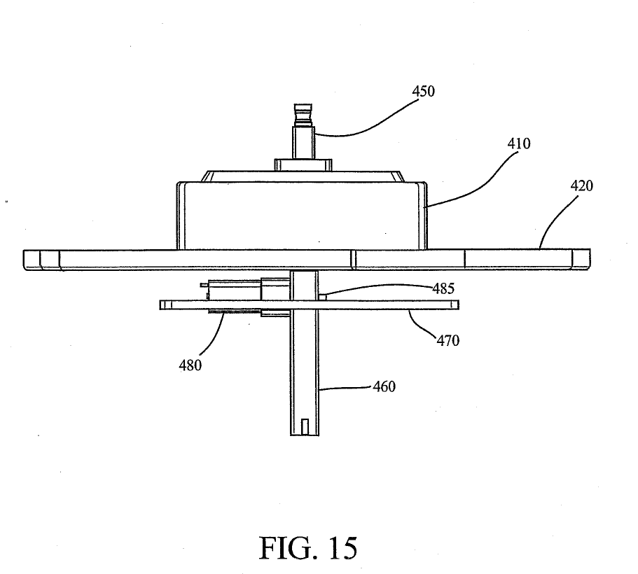

Referring next to FIG. 15, a side view is shown, viewed from a position 270° from that of FIG. 14, about a counter-clockwise axis of rotation of the ceiling fan in accordance with the embodiment of FIGS. 4-14, showing a first (upper) deck 420, a main drive shaft 450, a main drive shaft sleeve 460, a plate 470, a light cover deployment motor 480, and a light cover deployment motor mount 485. The light cover deployment motor 480 is in a position that has closed the gap 115 between the upper housing (not shown) and the light cover (not shown).

For a description of what is shown in FIG. 15, reference should be made to the detailed description made above in reference to FIG. 4-14.

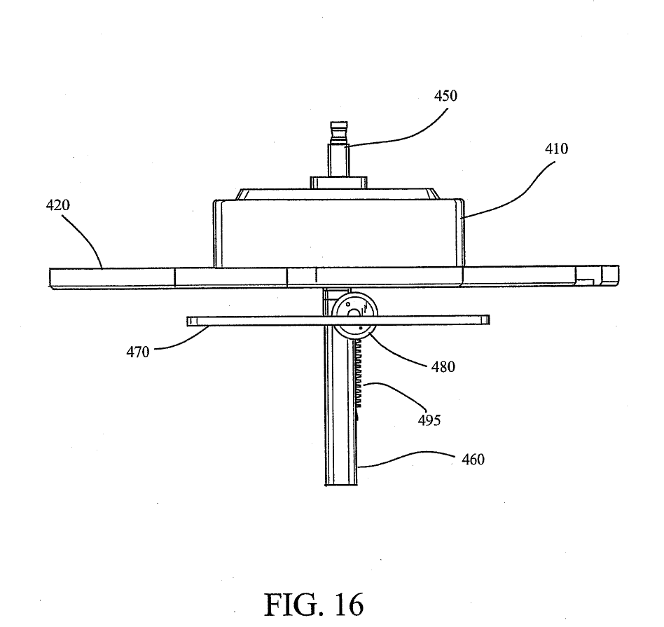

Referring next to FIG. 16, a side view is shown, viewed from a position 180° from that of FIG. 14, about an axis of rotation of the ceiling fan in accordance with the embodiment of FIGS. 4-15, showing a first (upper) deck 420, a main drive shaft 450, a main drive shaft sleeve 460, a plate 470, a light cover deployment motor 480, a light cover deployment motor mount 485, and a light cover deployment rack 495. The light cover deployment motor 480 is in a position that has closed the gap 115 between the upper housing (not shown) and the light cover (not shown).

For a description of what is shown in FIG. 16, reference should be made to the detailed description made above in reference to FIG. 4-15.

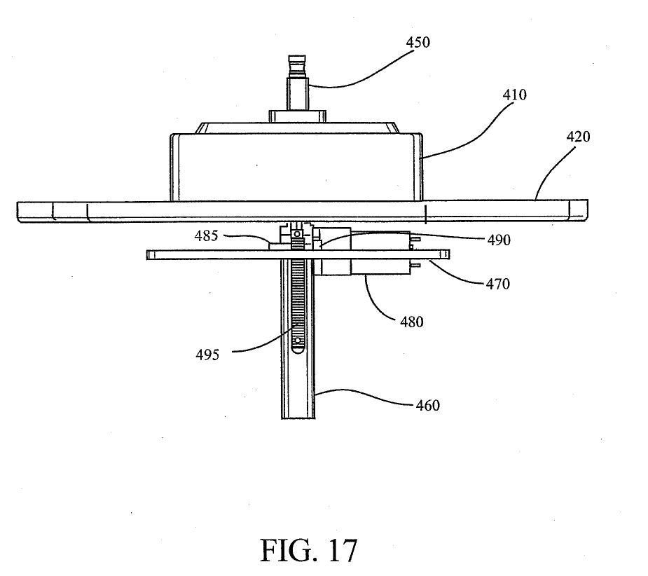

Referring next to FIG. 17, a side view is shown, viewed from a position 90° from that of FIG. 14, about a counter-clockwise axis of rotation of the ceiling fan in accordance with the embodiment of FIGS. 4-16, showing a first (upper) deck 420, a main drive shaft 450, a main drive shaft sleeve 460, a plate 470, a light cover deployment motor 480, a light cover deployment motor mount 485, a light cover deployment pinion 490, and a light cover deployment rack 495. The light cover deployment motor 480 is in a position that has closed the gap 115 between the upper housing (not shown) and the light cover (not shown).

For a description of what is shown in FIG. 17, reference should be made to the detailed description made above in reference to FIG. 4-16.

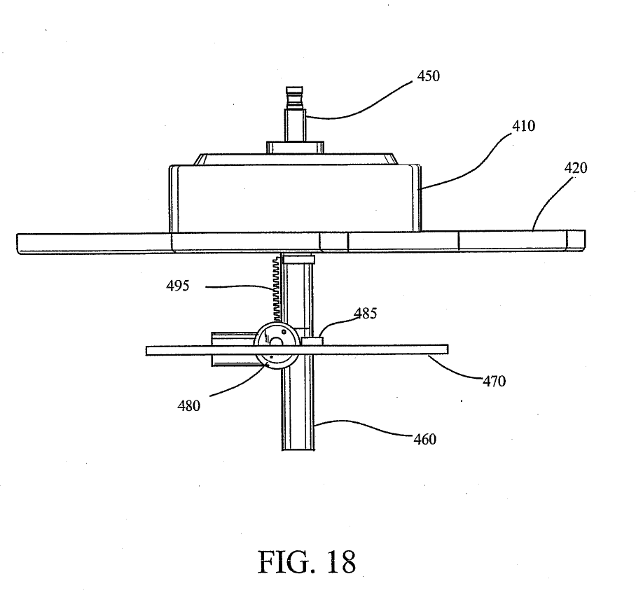

Referring next to FIG. 18, a side view of a ceiling fan in accordance with the embodiment of FIGS. 4-13, showing a main drive motor 410, a first (upper) deck 420, a main drive shaft 450, a main drive shaft sleeve 460, a plate 470, a light cover deployment motor 480, a light cover deployment motor mount 485, and a light cover deployment rack 495. The light cover deployment motor 480 is in a position that has opened the gap 115 between the upper housing (not shown) and the light cover (not shown).

For a description of what is shown in FIG. 18, reference should be made to the detailed description made above in reference to FIG. 4-13.

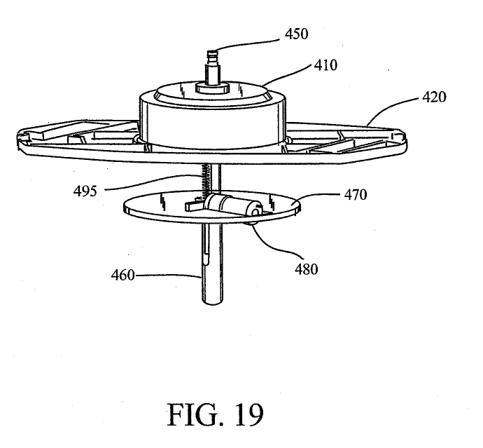

Referring next to FIG. 19, a perspective view of a ceiling fan in accordance with the embodiment of FIGS. 4-13, showing a main drive motor 410, a first (upper) deck 420, a main drive shaft 450, a main drive shaft sleeve 460, a plate 470, a light cover deployment motor 480, and a light cover deployment rack 495. The light cover deployment motor 480 is in a position that has opened the gap 115 between the upper housing (not shown) and the light cover (not shown).

For a description of what is shown in FIG. 19, reference should be made to the detailed description made above in reference to FIG. 4-13.

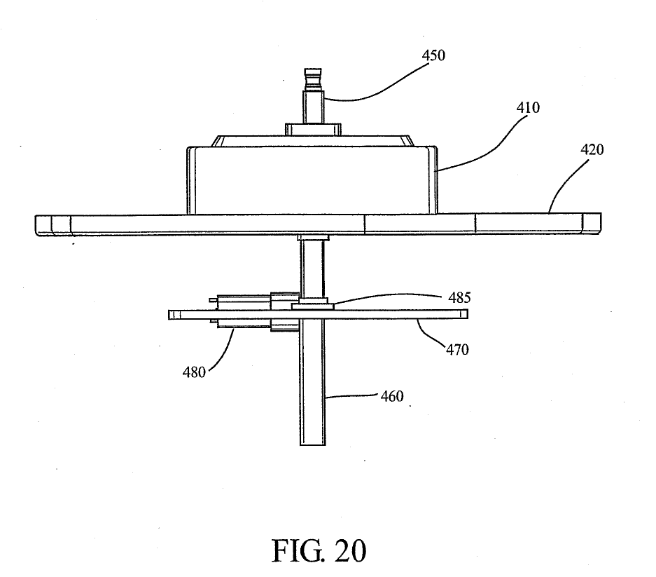

Referring next to FIG. 20, a side view is shown, viewed from a position 270° from that of FIG. 14, about a counter-clockwise axis of rotation of the ceiling fan in accordance with the embodiment of FIGS. 4-13, showing a first (upper) deck 420, a main drive shaft 450, a main drive shaft sleeve 460, a plate 470, a light cover deployment motor 480, and a light cover deployment motor mount 485. The light cover deployment motor 480 is in a position that has opened the gap 115 between the upper housing (not shown) and the light cover (not shown).

For a description of what is shown in FIG. 20, reference should be made to the detailed description made above in reference to FIG. 4-13.

Referring to FIG. 21, a flow diagram is shown illustrating a “startup” sequence employed by a control system for controlling the ceiling fan described of the various embodiments described hereinabove in reference to FIGS. 1 through 20.

At the outset, a signal is sent (such as by the activation of a wall switch, a switch accessible from the housing of the ceiling fan, or a wired or wireless remote control) to a control device (such as a microcontroller or a microprocessor, modified with control software that controls one or more electromechanical or solid state switches that control the application of power to the main drive motor, the deployment motor(s), the light cover deployment motor, one or more mechanical or electrical switches or shifting mechanisms) initiating the startup sequence.

In response thereto, in accordance with one embodiment, a main drive motor and the deployment motor(s) are activated. The main drive motor is activated after a time delay (i.e. a time period sufficient to allow the blades to at least partially deploy, which may include time needed for a light cover to lower).

After the time delay, the main drive motor starts to turn the deck (in a direction selected by a user) at a low speed allowing the control device to run a wobble test to ensure that the blades have fully deployed (using wobble sensors such as a simple tilt switch or an electrolytic tilt sensor). If a wobble is detected (i.e. blades have not fully deployed and are significantly out of position), the control will go to “shutdown” sequence, as described herein below, and the control will stop the main drive motor from rotating. However, if a wobble is not detected, the control will start the fan at a speed selected by the user.

The “startup” sequence may also involve the controller commanding a lowering of a light cover (or housing). After detecting (via sensors, such as a current sensor) that the light cover has lowered, the control activates the blade deployment motor(s) and the main drive motor (provided that a wobble is not detected). However, if the control detects that the light cover has not fully lowered after a specified time, the control will go to “shutdown” mode as described herein below.

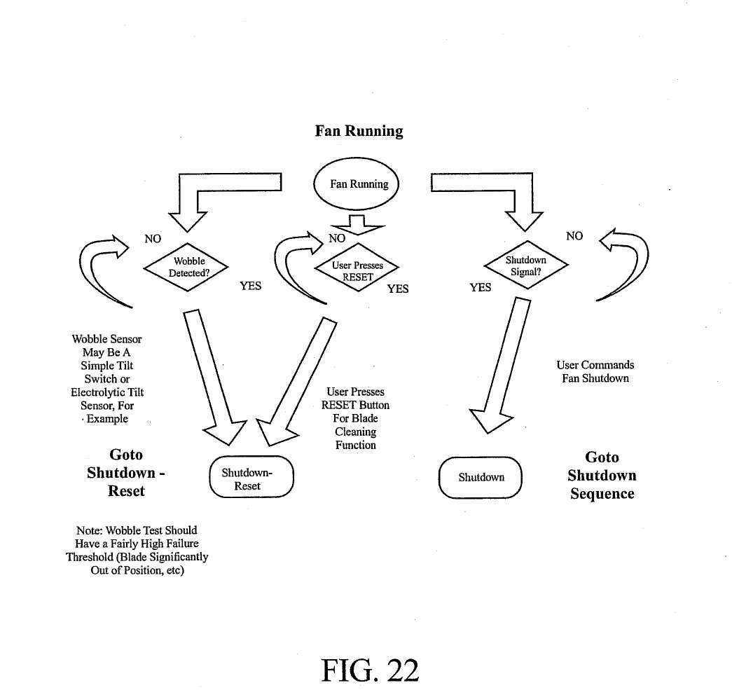

Referring to FIG. 22, a flow diagram is shown illustrating a “running” sequence employed by a control system for controlling the ceiling fan described of the various embodiments described hereinabove in reference to FIGS. 1 through 20.

At the outset, the control device (such as a microcontroller or microprocessor modified with control software that controls one or more electromechanical or solid state switches that control the application of power to the main drive motor, the deployment motor(s), the light cover deployment motor, one or more mechanical or electrical switches or shifting mechanisms) continuously operates the fan at a desired speed and direction until a signal is received, either from a user controlled device, indicating a “shutdown” or a “reset” of the fan, or via a wobble sensor (such as a simple tilt switch or an electrolytic tilt sensor) indicating an imbalance in the fan blades relative to the entire fan.

In response thereto, in accordance with one embodiment, the controller will go to a “shutdown” sequence as described herein below.

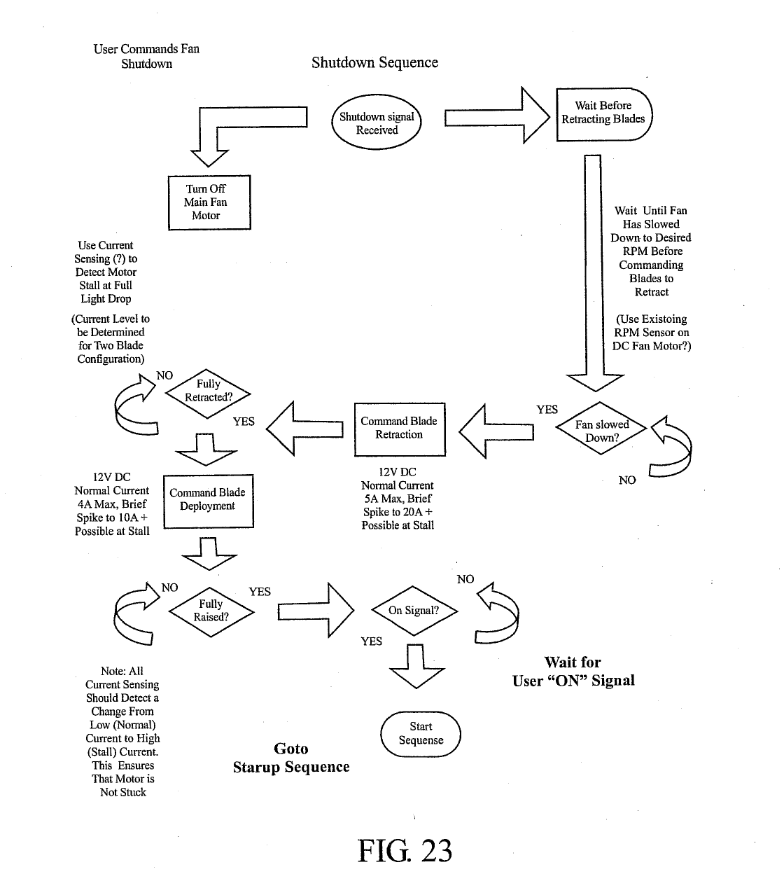

Referring to FIG. 23, a flow diagram is shown illustrating a “shutdown” sequence employed by a control system for controlling the ceiling fan described of the various embodiments described hereinabove in reference to FIGS. 1 through 20.

At the outset, the control device (such as a microcontroller or microprocessor modified with control software that controls one or more electromechanical or solid state switches that control the application of power to the main drive motor, the deployment motor(s), the light cover deployment motor, one or more mechanical or electrical switches or shifting mechanisms) continuously operates the fan at a desired speed and direction until a “shutdown” signal is received, either from a user controlled device indicating a “shutdown” of or a “reset” of the fan, or via a wobble sensor (such as a simple tilt switch or an electrolytic tilt sensor) indicating an imbalance in the fan blades relative to the entire fan.

In response thereto, in accordance with one embodiment, the controller will go to the “shutdown” sequence, whereby a main drive motor termination signal is activated and power to the main drive motor is cutoff. After the fan blades have slowed down (to a preset low RPM as detected by a sensor, such as a RPM sensor), the controller will activate the deployment motor to retract the fan blades.

After the fan blades are fully retracted (as detected by a sensor, such as a current sensor) the controller will command a raising of the lowered light cover (or housing). After the controller receives a signal detecting that the light cover has fully raised (i.e. the housing has closed) the controller will wait for a “start up” signal.

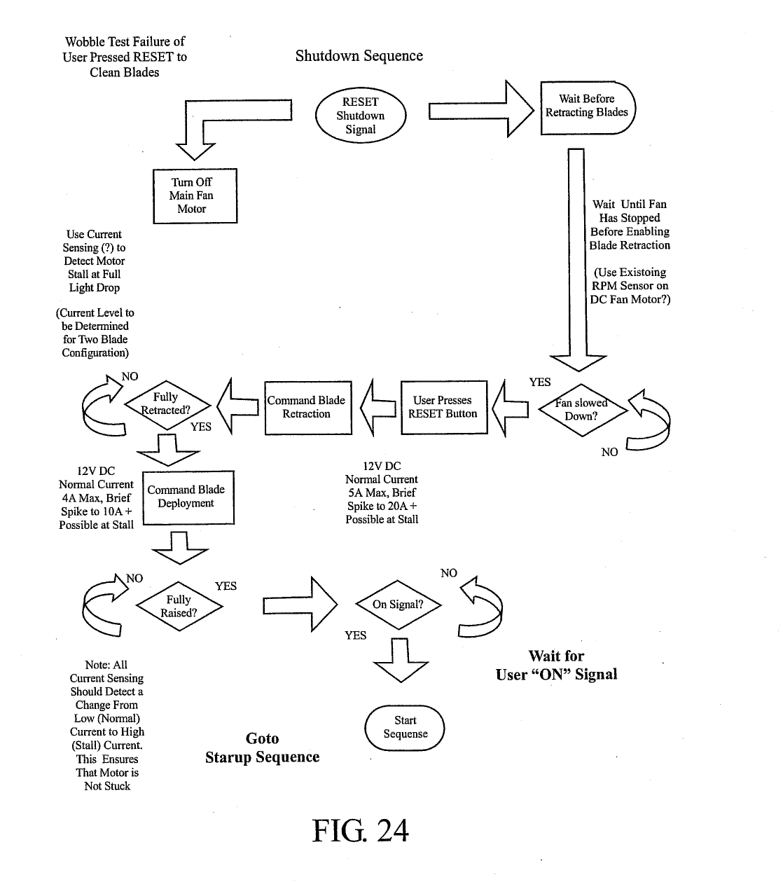

Referring to FIG. 24, a flow diagram is shown illustrating a “shutdown-reset” sequence employed by a control system for controlling the ceiling fan described of the various embodiments described hereinabove in reference to FIGS. 1 through 20.

At the outset, a “reset” signal is sent (such as by the wobble sensor, or by a user activation of a wall switch, a switch accessible from the housing of the ceiling fan, or a wired or wireless remote control) to a control device (such as a microcontroller or microprocessor modified with control software that controls one or more electromechanical or solid state switches that control the application of power to the main drive motor, the deployment motor(s), the light cover deployment motor, one or more mechanical or electrical switches or shifting mechanism) initiating the “reset” sequence (or a cleaning mode).

In response thereto, in accordance with one embodiment, the controller will go to the “reset” sequence, whereby a main drive motor termination signal is activated and power to a main drive motor is cutoff, and the blades will remain in its existing deployed position. After the fan blades have stopped due to the activation of the “reset” sequence (as detected by a sensor, such as a RPM sensor), if the user activates “reset” sequence, the blades will then retract (and if applicable the housing unit will close). The controller will then wait for a start up signal.

While the invention herein disclosed has been described by means of specific embodiments, examples and applications thereof, numerous modifications and variations could be made thereto by those skilled in the art without departing from the scope of the invention set forth in the claims.

What is claimed is:

1. A fan comprising:
a first housing portion;
a second housing portion; and
a motive unit operably coupled to the second housing portion, wherein the motive unit is configured to adjust a position of the second housing portion from a position proximate to the first housing portion to a position distal to the first housing portion.

2. The fan of claim 1, further comprising:
the motive unit is further configured to adjust a position of the second housing portion from the position distal to the first housing portion to the position proximate to the first housing portion.

3. The fan of claim 1, further comprising:
wherein the second housing unit is of a material that is transmissive to light.

4. A fan comprising:
a first housing portion;
a second housing portion; and
a means for positioning the second housing portion from a position proximate to the first housing portion to a position distal to the first housing portion.

5. The fan of claim 4, further comprising:
a means for positioning the second housing portion from the position distal to the first housing portion to the position proximate to the first housing portion.

6. A method for adjusting a position of a fan housing unit, comprising the steps of:
providing a signal to a motive unit, wherein the motive unit is operably coupled to a first housing portion;
adjusting a position of the first housing portion from a position proximate to a second housing portion to a position distal to a second portion.

7. The method of claim 6, further comprising the steps of:
adjusting a position of the first housing portion from the position distal to the second housing portion to the position proximate to the second portion.

8. A fan comprising:
a housing portion;
a support deck, wherein the support deck provides support to a blade; and
a motive unit operably coupled to the housing portion, wherein the motive unit is configured to adjust a position of the housing portion from a position proximate to the support deck to a position distal to the support deck.

9. The fan of claim 8, further comprising:
the motive unit is further configured to adjust a position of the housing portion from the position distal to the support deck to the position proximate to the support deck.
